(19) United States
(12) Patent Application Publication
(10) Pub. No.: US 2003/0107962 A1
(43) Pub. Date: Jun. 12, 2003

(54) Link method and system for providing recorded data continuity in a compact disc

(76) Inventor: Hyung-joon Kwon, Seoul (KR)

Correspondence Address: Frank Chau, Esq., F. CHAU & ASSOCIATES, LLP, 1900 Hempstead Turnpike, East Meadow, NY, 11554, US

(21) Appl. No.: 10/272,428

(22) Filed: Oct. 16, 2002

(30) Foreign Application Priority Data
Oct. 16, 2001 (KR) 2001-63765

(51) Int. Cl. G11B 5/09

(52) U.S. Cl. 369/47.1

(57) ABSTRACT

A link method and system for providing recorded data continuity in a compact disc. When a buffer underrun occurs, the width of an EXTENDED SYNC signal indicating the time interval between an absolute time in pre-groove synchronization (ATIP SYNC) signal and a SUBCODE SYNC signal is stored in a predetermined place, and is then used for accurate data recording continuity when data recording restarts after the buffer underrun is corrected.

### CROSS REFERENCE TO RELATED APPLICATION

This application claims priority to Korean Patent Application No. 01-63765 filed on Oct. 16, 2001, which is fully incorporated herein by reference.

### TECHNICAL FIELD

The present invention relates to a re-writable compact disc (CD-RW), and more particularly, to a link method and system for providing accurate continuity of data that is recorded on a recordable/re-writable compact disc (CD-R/CD-RW) before and after the occurrence of a buffer underrun.

### BACKGROUND

Methods for recording predetermined data on CD-R/RW discs typically comply with the linking/synchronization rules of the Orange Book, which presents a variety of recommendations using CD-R/RW disks. By way of example, FIG. 1 is an exemplary signal timing diagram illustrating a normal linking/synchronization method recommended by the CD-R/RW Orange Book. An absolute time in pre-groove (ATIP) synchronization (SYNC) signal is a CD-embedded signal formed during manufacturing, while a SUBCODE SYNC signal and a SECTOR SYNC signal are generated by an encoder (not shown). By reading the ATIP SYNC signal, data recording on a CD-R/RW disk starts. Then, 9.3 eight to fourteen modulation (EFM) frames after the ATIP SYNC signal is enabled, the encoder generates a SUBCODE SYNC signal. An EXTENDED ATIP SYNC signal represents the time period corresponding to the 9.3 EMF frames.

Then, 26 EFM frames after the SUBCODE SYNC signal is enabled, a SECTOR SYNC signal is generated. A recording command signal (WGATE), which is enabled by the SECTOR SYNC signal, starts main data recording. According to recording process recommendations of the Orange Book, the ATIP SYNC signal is generated every 98 EFM frames.

When data recording starts, the above-described signals are adjusted so that the signals can be synchronized. However, during data recording, for example, the signals may not be always synchronized due to the instability of a spindle servo. That is, when the signals are synchronized, a SUBCODE SYNC signal should be generated 9.3 EFM frames after the ATIP SYNC signal is enabled. However, the SUBCODE SYNC signal may occur earlier or later than the 9.3 EMF frame time interval.

FIG. 2 is an exemplary signal timing diagram illustrating a buffer underrun occurrence (OVERLAP) when a time interval between an ATIP SYNC and a SUBCODE SYNC contains more than 9.3 EFM frames. The OVERLAP period shown in FIG. 2 depicts a case where the interval between the ATIP SYNC and SUBCODE SYNC is increased because the rotation of the disc is slowed down. In one EFM frame, a CHANNEL CLOCK signal having 558 cycles is included. It is to be noted that for purposes of illustration, FIG. 2 depicts an OVERLAP period corresponding to a small number of channel clock cycles, and that the overlap period may comprise a plurality of EFM frames. The signals shown in FIG. 2 will now be explained. When a recording command signal (WGATE1) is in a “high” logic level, data (A) is recorded on the CD, and if the recording command signal (WGATE1) transitions to a “low” logic level, the recording operation stops. The transition of the recording command signal (WGATE1) to a “low” logic level means that a buffer underrun has occurred. Then, after the buffer underrun is corrected, the recording command signal (WGATE2) transitions to a “high” logic level, and data (B) is continuously recorded on the sectors proceeding the sector in which data recording stopped due to the occurrence of the buffer underrun. For purposes of data continuity, the data (A+B) to be recorded should have data continuity with data recorded on the sector where data recording was previously completed.

It is to be noted that the two recording command signals (WGATE1 and WGATE2) are actually the same signal, but for the convenience of explanation, the recording command signal before the time when the buffer underrun occurs is referred to herein as WGATE1, and the recording command signal after the same time is referred to herein as WGATE2.

It is difficult to synchronize the recording command signal (WGATE1) used when data recording stopped due to the occurrence of the buffer underrun, with the recording command signal (WGATE2) which is used for data recording after the buffer underrun is corrected. This is because when the buffer underrun occurs, the state of the recording command signal (WGATE1) is not maintained and, in general, the recording command signal (WGATE2) to be used for data recording after the buffer underrun is corrected, is compulsorily adjusted to occur 9.3 EFM frames after an ATIP SYNC signal is enabled.

Therefore, as described above, if a buffer underrun occurs when data is recorded in a time interval between an ATIP SYNC and a SUBCODE SYNC containing more than 9.3 EFM frames, it is difficult to distinguish between data recorded after the buffer underrun is corrected on a sector on which data recording stopped due to the buffer underrun, and data on a sector on which data recording was completed. Therefore, an overlap of data recording occurs.

FIG. 3 is an exemplary signal timing diagram illustrating a buffer underrun occurrence (GAP) in a time interval between an ATIP SYNC and a SUBCODE SYNC containing less than 9.3 EFM frames. The GAP period in FIG. 3 depicts a case where the interval between the ATIP SYNC signal and the SUBCODE SYNC signal is narrowed because the rotation of the disc is increased. It is to be noted that for purposes of illustration, FIG. 3 depicts the GAP period corresponding to a small number of channel clock cycles, and that the GAP period may comprise a plurality of EFM frames.

The signals shown in FIG. 3 will now be explained. When a recording command signal (WGATE3) is in a “high” logic level, data (C) is recorded on the CD, and if the recording command signal (WGATE3) transitions to a “low” logic level, the recording operation stops. The transition of the recording command signal (WGATE3) to a “low” logic level means that a buffer underrun has occurred. After the buffer underrun is corrected, the recording command signal (WGATE4) transitions to a “high” logic level, and data (D) is continuously recorded on the sectors proceeding the sector in which data recording stopped due to the occurrence of the buffer underrun. Data (C+D) to be recorded should have data continuity with data recorded on the sector where data recording was previously completed.

It is to be noted that the two recording command signals (WGATE3 and WGATE4) are actually the same signal, and are the same signals as the two recording command signals (WGATE1 and WGATE2) shown in FIG. 2. For the convenience of explanation, the recording command signal before the time when the buffer underrun occurs is referred to herein as WGATE3, and the recording command signal after the same time is referred to herein as WGATE4.

It is difficult to synchronize the recording command signal (WGATE3), which is used when data recording stopped due to the occurrence of the buffer underrun, with the recording command signal (WGATE4), which is used for data recording after the buffer underrun is corrected. The inconsistency in synchronizing signals is due to the same reasons explained above for FIG. 2, and therefore the explanation is omitted.

If a buffer underrun occurs when data is recorded in a time interval between an ATIP SYNC and a SUBCODE SYNC containing less than 9.3 EFM frames, the data that is to be recorded after the buffer underrun is corrected on a sector on which data recording stopped due to the buffer underrun, is not recorded on a sector that immediately follows the sector on which data recording was completed. Thus, a small gap (GAP) occurs between the sector on which data recording was completed and the following sector on which data is to be recorded.

In general, when the speed of transmitting data from a host (for example, a personal computer (PC)) is slower than the speed of recording data on a CD-R/RW disk, a buffer underrun occurs. The frequency of occurrence of the buffer underrun depends on the data transmitting speed of the host and the load on the host. The buffer underrun is a critical error in data recording on a CD-R/RW disk. Therefore, if the buffer underrun occurs during data recording on a CD-R disk, the CD-R disk should be discarded, and if the buffer underrun occurs during data recording on a CD-RW, all data recorded on the recording areas should be deleted and data should be recorded again from the beginning.

To solve the above problems, conventional methods include performing data recording at a slower speed, or increasing the size of a memory embedded in a CD-RW disk drive so as to store more data. However, though scaling up the size of the embedded memory may reduce the frequency of the occurrence of the buffer underrun, this process does not afford an ultimate solution to prevent the occurrence of the buffer underrun.

Therefore, an apparatus and method for accurately maintaining continuity between data that is recorded up to the occurrence of a buffer underrun, and data that is recorded after the buffer underrun is corrected, is highly desirable.

### SUMMARY OF THE INVENTION

The present invention is directed to a link method and system for providing data continuity between data recorded before the occurrence of a buffer underrun and the data recorded after the correction of the buffer underrun.

There is also provided another embodiment of a link method and system for controlling an interval between an absolute time in pre-groove (ATIP) synchronization signal, which is recorded when a compact disc (CD) is manufactured, and a subcode synchronization signal, which is generated in an encoder by the ATIP synchronization signal, in order to satisfy data continuity of data recorded before the occurrence and after the correction of a buffer underrun. When data recording stops due to the occurrence of the buffer underrun in recording predetermined data on the CD and then data recording restarts after the buffer underrun is corrected, the link method comprises the steps of storing continuously the time intervals between the ATIP synchronization signal and the subcode synchronization signal when data recording is performed; and compensating a time interval between the ATIP synchronization signal and the subcode synchronization signal by using the stored time interval when data recording restarts after the buffer underrun is corrected. In the storing of the time intervals, preferably, the time intervals are not stored when buffer underrun occurs, and the time intervals are stored when data recording restarts after the buffer underrun is corrected.

There is also provided embodiment of a system for controlling an interval between an absolute time in pre-groove (ATIP) synchronization signal, which is recorded when a compact disc (CD) is manufactured, and a subcode synchronization signal, which is generated in an encoder by the ATIP synchronization signal. The system provides for recorded data continuity when data is recorded in a compact disc before a buffer underrun occurs and after the buffer underrun is corrected, the system comprising: a memory unit for storing continuously time intervals between an absolute time in pre-groove (ATIP) synchronization signal and a subcode synchronization signal when data recording is performed; and a controller for compensating a time interval between the ATIP synchronization signal and the subcode synchronization signal by using the stored time intervals when data recording restarts after the buffer underrun is corrected, wherein the time intervals are not stored when a buffer underrun occurs, and the time intervals are stored when data recording restarts after the buffer underrun is corrected. The system in storing the time intervals has a stored time interval as equal as the number of clock cycles used in recording data on the CD.

### BRIEF DESCRIPTION OF THE DRAWINGS

The objects and advantages of the present invention will become apparent by describing in more detail preferred embodiments thereof with reference to the attached drawings in which:

FIG. 1 is an exemplary signal timing diagram illustrating normal linking/synchronization process as recommended by the CD-R/RW Orange Book;

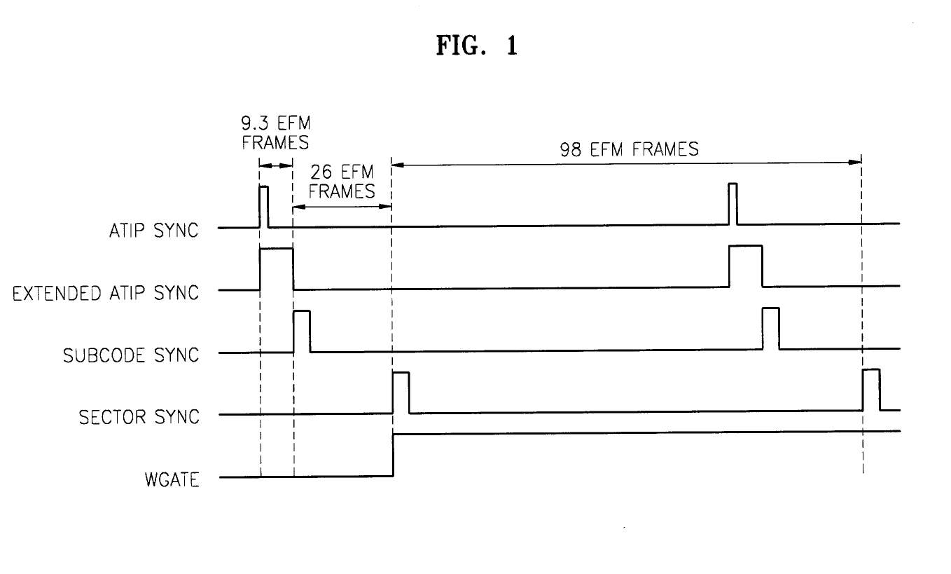

FIG. 2 is an exemplary signal timing diagram illustrating a buffer underrun occurrence (OVERLAP) in a time interval between an ATIP SYNC signal and a SUBCODE SYNC signal, containing more than 9.3 EFM frames;

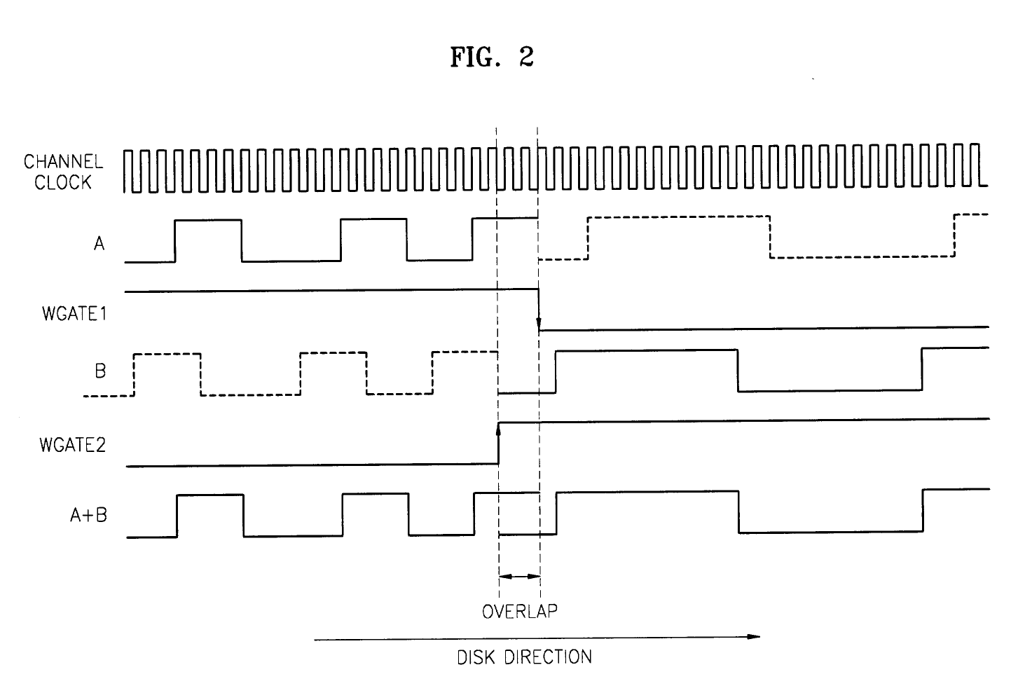

FIG. 3 is an exemplary signal timing diagram illustrating a buffer underrun occurrence (GAP) in a time interval between an ATIP SYNC signal and a SUBCODE SYNC signal containing less than 9.3 EFM frames;

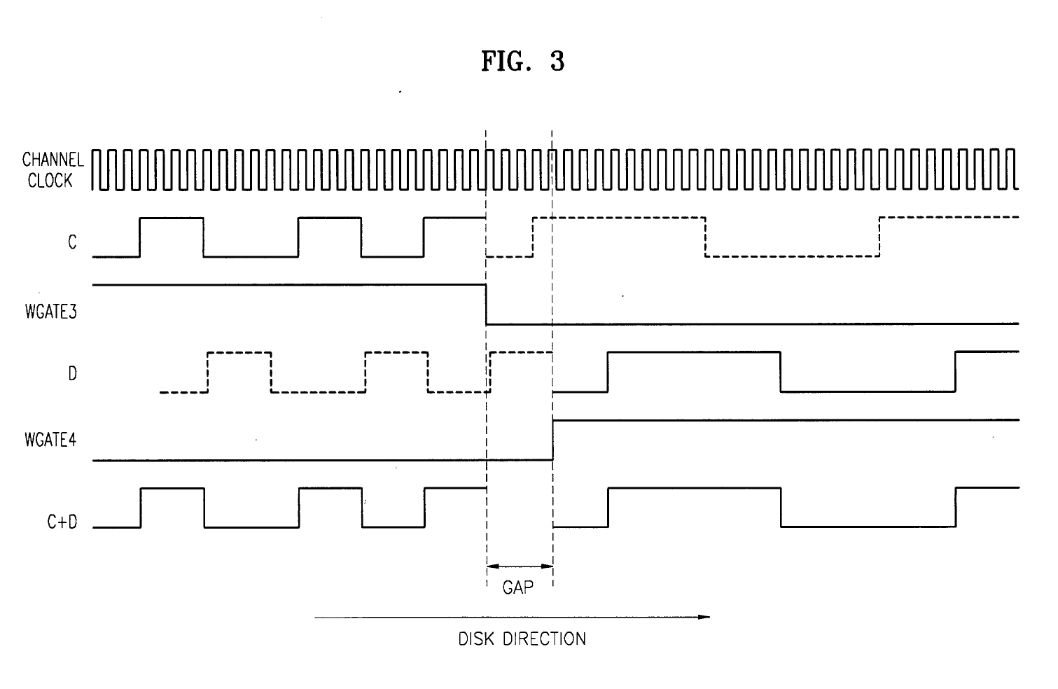

FIG. 4 is a timing diagram of a buffer underrun occurrence in a link method and system according to an embodiment of the present invention; and

FIG. 5 is a timing diagram when data recording is performed after a buffer underrun occurrence is corrected in a link method and system according to an embodiment of the present invention.

### DESCRIPTION OF PREFERRED EMBODIMENTS

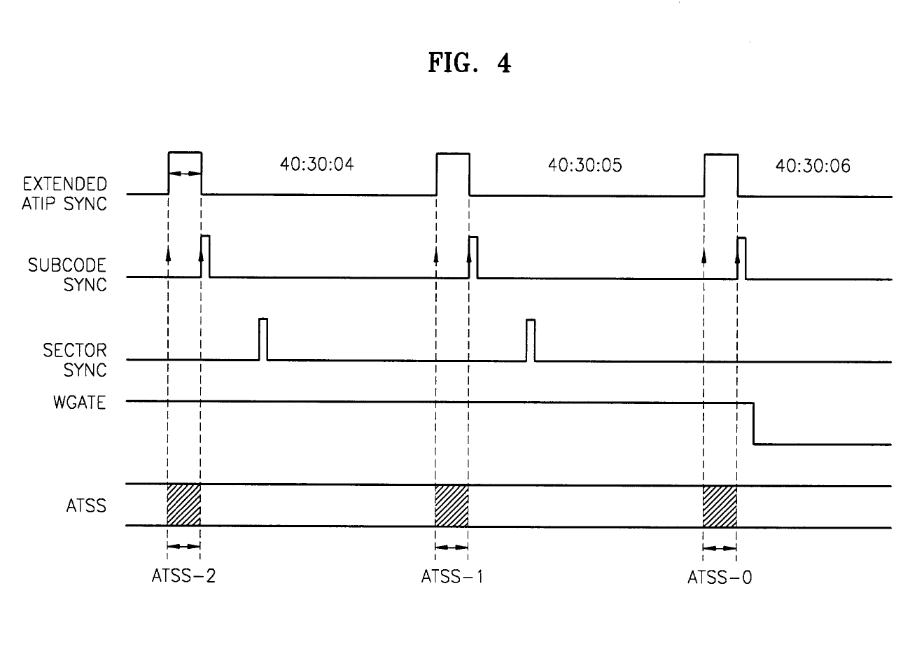

FIG. 4 is an exemplary timing diagram for explaining a buffer underrun occurrence in a link method according to an embodiment of the present invention. Referring to FIG. 4, if a buffer underrun occurs, the time intervals ATSS-0, ATSS-1, and ATSS-2 are stored in predetermined locations. ATSS-0 denotes the width of EXTENDED ATIP SYNC when a buffer underrun occurs (40:30:05), and ATSS-1 and ATSS-2 respectively denote the widths of EXTENDED ATIP SYNC before a buffer underrun occurs. Here, 40:30:05 indicates information on recorded data, wherein the three pairs of numbers indicate the minute, second, and frame, respectively, of the recorded data. Preferably, the predetermined storage comprises a plurality of shift registers. Here, the width of the EXTENDED ATIP SYNC signal indicates the time interval between the ATIP SYNC signal and the SUBCODE SYNC signal.

In the example of FIG. 4, wherein the buffer underrun is assumed to have occurred at 40:30:05, if data recording restarts after the buffer underrun is corrected, data should be recorded starting from the same information value, i.e., 40:30:05. Data recording is performed when the recording command signal (WGATE) is in a “high” logic level. The recording command signal (WGATE) is generated at a predetermined time after the SUBCODE SYNC signal (which is generated by the ATIP SYNC signal) is enabled. Therefore, data continuity of recorded data before and after the occurrence of the buffer underrun can be maintained when the time interval between the ATIP SYNC signal and the SUBCODE SYNC signal (i.e., extended ATIP signal) prior to the buffer underrun coincides with such time interval after the buffer underrun is corrected.

A cross interleaved reed-solomon code (CIRC) method is typically used to record data on a CD. Therefore, to restart data recording, information on a sector (40:30:03) positioned two sectors before the buffer underrun occurrence sector (40:30:05) on which data is to be recorded is needed. In this respect, according to the present invention, the time interval between the ATIP SYNC signal and the SUBCODE SYNC signal (i.e., extended ATIP signal) at the time when the buffer underrun occurs and such time interval at a sector positioned two sectors before the buffer underrun occurrence sector, are stored. Also, when data recording restarts, the time interval before the occurrence of the buffer underrun can be restored using the stored data. However, the time intervals of continuous sectors are similar to each other, and the time interval of only one sector before the occurrence of the buffer underrun may be used for restoring the time interval.

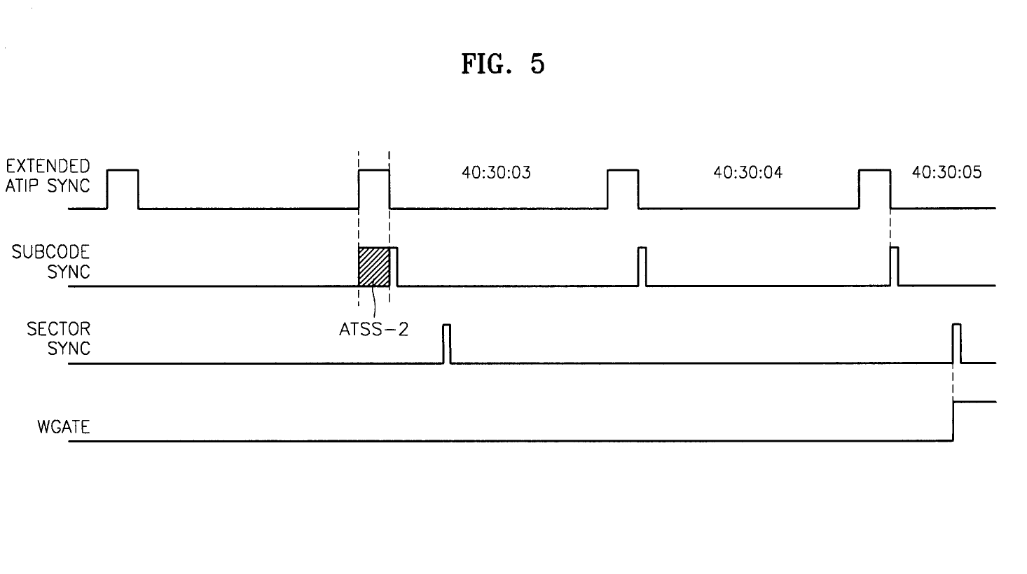

FIG. 5 is an exemplary timing diagram illustrating when data recording is performed after a buffer underrun occurrence is corrected in a link method and system according to an embodiment of the present invention. FIG. 5, which is now explained, is a time succession of FIG. 4 and shows a moment when data recording restarts after the buffer underrun occurred in FIG. 4 is corrected.

Since the buffer underrun occurred at 40:30:05, if data recording restarts after the buffer underrun is corrected, the time interval corresponding to a sector that is positioned two sectors before the sector on which data recording was stopped due to the occurrence of the buffer underrun is needed. Therefore, using the time interval stored at 40:30:03, the width of the EXTENDED ATIP SYNC signal can be adjusted. Also, the recording command signal (WGATE) is controlled to transition from a “low” logic level to a “high” logic level for recording.

With a link method and system according to an embodiment of the present invention, as described above, if the buffer underrun occurs, the width of the EXTENDED SYNC signal indicating the time interval between the ATIP SYNC signal and the SUBCODE SYNC signal when the buffer underrun occurred is stored in a predetermined place, and is then used when data recording restarts after the buffer underrun is corrected.

When the buffer underrun occurs, in order to solve this problem and to maintain continuous recording, a type of linking that has no OVERLAP and no GAP is preferred. In case of a buffer underrun, when data is needed to be continuously recorded after the current sector on which data recording is completed, data recording continuity is not guaranteed by simply beginning to record data in synchronization with the ATIP SYNC signal of the current sector.

To ensure data continuity, when data recording on a sector is desired to be performed after the buffer underrun is corrected, a link method and system according to an embodiment of the present invention does not follow the first synchronization rule for the time interval between the ATIP SYNC signal and the SUBCODE SYNC signal, but makes an accurate time interval between the ATIP SYNC signal and the SUBCODE SYNC signal when data recording is stopped due to the occurrence of the buffer underrun.

It is to be understood that a method and system described herein in accordance with the present invention may be implemented in various forms of hardware, software, firmware, special purpose processors, or a combination thereof. Preferably, the present invention is implemented in software comprising program instructions that are tangibly embodied on one or more program storage devices (e.g., magnetic floppy disk, RAM, ROM), and executable by any device or machine comprising suitable architecture.

A link method and system according to an embodiment of the present invention, as described above, can minimize or eliminate the overlap and gap periods that may occur in data recorded on a CD before the occurrence of a buffer underrun and after the correction of the buffer underrun. In advantages, the invention minimizes the number of CDs having poor quality recorded data and therefore also contributes to the economic aspect.

Although illustrative embodiments have been described with reference to the drawings and specification, and although specific terminologies are used here, it is to be understood that the present invention is not restricted to the above-described embodiments and many variations are possible within the spirit and scope of the present invention. The scope of the present invention is not determined by the description but by accompanying claims.

What is claimed is:

1. A method for controlling an interval between an absolute time in pre-groove (ATIP) synchronization signal, which is recorded when a compact disc (CD) is manufactured, and a subcode synchronization signal, which is generated in an encoder by the ATIP synchronization signal, to provide data continuity of data recorded before the occurrence and after the correction of a buffer underrun, when data recording stops due to the occurrence of the buffer underrun in recording predetermined data on the CD and then data recording restarts after the buffer underrun is corrected, the link method comprising:
continuously storing time intervals between the ATIP synchronization signal and the subcode synchronization signal while data recording is performed; and
compensating a time interval between the ATIP synchronization signal and the subcode synchronization signal by using the stored time intervals when data recording restarts after the buffer underrun is corrected,
wherein the time intervals are not stored when a buffer underrun occurs, and the time intervals are stored when data recording restarts after the buffer underrun is corrected.

2. The method of claim 1, wherein a stored time interval comprises a number of clock cycles used in recording data on the CD.

3. The method of claim 1, wherein the step of storing the time intervals further comprises:
determining a time when the buffer underrun occurs; and
sequentially storing the time interval of the time of the occurrence of the buffer underrun and at least one time interval before the time of the occurrence of the buffer underrun.

4. The method of claim 1, wherein in storing the time intervals, the plurality of time intervals are continuously shifted and stored using a plurality of shift registers.

5. The method of claim 1, wherein the step of compensating the time interval further comprises using a time interval at the time when the buffer underrun occurs and at least one time interval immediately before the time of the occurrence of the buffer underrun, to compensate the time interval between the ATIP synchronization signal and the subcode synchronization signal.

6. A system for providing recorded data continuity when data is recorded in a compact disc before a buffer underrun occurs and after the buffer underrun is corrected, the system comprising:
a memory for continuously storing time intervals between an absolute time in pre-groove (ATIP) synchronization signal and a subcode synchronization signal while data recording is performed; and
a controller for compensating a time interval between the ATIP synchronization signal and the subcode synchronization signal by using the stored time intervals when data recording restarts after the buffer underrun is corrected,
wherein the time intervals are not stored when a buffer underrun occurs, and the time intervals are stored when data recording restarts after the buffer underrun is corrected.

7. The system of claim 6, wherein a stored time interval comprises a number of clock cycles used in recording data on the CD.

8. The system of claim 6, wherein, when the controller determines that the buffer underrun occurs, the memory sequentially stores the time interval at the buffer underrun occurrence sector and a time interval at a sector positioned at most two sectors before the buffer underrun occurrence sector.

9. The system of claim 6, wherein the memory comprises a plurality of shift registers for continuously shifting and storing the plurality of time intervals.

10. The system of claim 6, wherein the controller compensates the time interval by taking into consideration a time interval at the time when the buffer underrun occurs and at least one time interval immediately before the time of the occurrence of the buffer underrun, to compensate the time interval between the ATIP synchronization signal and the subcode synchronization signal.

11. A program storage device readable by machine, tangibly embodying a program of instructions executable by the machine to perform method steps for providing recorded data continuity when data is recorded in a compact disc before a buffer underrun occurs and after the buffer underrun is corrected, the method steps comprising:
continuously storing time intervals between an absolute time in pre-groove (ATIP) synchronization signal and a subcode synchronization signal when data recording is performed; and
compensating a time interval between the ATIP synchronization signal and the subcode synchronization signal by using the stored time intervals when data recording restarts after the buffer underrun is corrected,
wherein the time intervals are not stored when a buffer underrun occurs, and the time intervals are stored when data recording restarts after the buffer underrun is corrected.

12. The program storage device of claim 11, wherein a stored time interval comprises a number of clock cycles used in recording data on the CD.

13. The program storage device of claim 11, wherein the instructions for compensating the time interval between the ATIP synchronization signal and the subcode synchronization signal comprise instructions for:
determining a time when the buffer underrun occurs; and
storing sequentially the time interval of the time of the occurrence of the buffer underrun and at least one time interval before the time of the occurrence of the buffer underrun.

14. The program storage device of claim 11, wherein the instructions for storing time intervals further comprise instructions for continuously shifting and storing the plurality of time intervals using a plurality of shift registers.

15. The program storage device of claim 11, wherein the instructions for compensating the time interval between the ATIP synchronization signal and the subcode synchronization signal comprise instructions for compensating the time interval by taking into consideration a time interval at the time when the buffer underrun occurs and at least one time interval immediately before the time of the occurrence of the buffer underrun.
